(19) United States
(12) Patent Application Publication
(10) Pub. No.: US 2013/0081065 A1
(43) Pub. Date: Mar. 28, 2013

(54) Dynamic Multidimensional Schemas for Event Monitoring

(71) Applicants: Dhiraj Sharan, Sunnyvale, CA (US); Steve Chan, Cupertino, CA (US); Christian Friedrich Beedgen, Mountain View, CA (US); Hugh S. Njemanze, Los Altos, CA (US)

(72) Inventors: Dhiraj Sharan, Sunnyvale, CA (US); Steve Chan, Cupertino, CA (US); Christian Friedrich Beedgen, Mountain View, CA (US); Hugh S. Njemanze, Los Altos, CA (US)

(21) Appl. No.: 13/700,330

(22) PCT Filed: Jun. 1, 2011
(86) PCT No.: PCT/US2011/038745

§ 371 Date: Nov. 27, 2012

Related U.S. Application Data
(60) Provisional application No. 61/350,593, filed on Jun. 2, 2010.

(51) Int. Cl. G06F 9/54

(52) U.S. Cl. CPC G06F 9/542
USPC 719/318

(57) ABSTRACT

Mapping event data to a domain schema includes receiving (301) event data for an event, wherein the event data is arranged in a source schema of a data source providing the event data. A best fit domain schema is determined (302) from a plurality of domain schemas, wherein the domain schemas include different fields from the source schema. The event data in the source schema is mapped (303) to the best fit domain schema.

### PRIORITY

The present application claims priority to U.S. Provisional Patent Application Ser. No. 61/350,593, filed Jun. 2, 2010, which is incorporated by reference in its entirety.

### BACKGROUND

Network security management is generally concerned with collecting data from network devices that reflects network activity and operation of the devices, and analyzing the data to enhance security. For example, the data can be analyzed to identify an attack on the network. If the attack is ongoing, a countermeasure can be performed to thwart the attack or mitigate the damage caused by the attack.

The data that is collected may originate in messages or in entries in log files generated by the network devices and applications, which may include firewalls, intrusion detection systems, servers, routers, switches. The collected data that is received from the reporting devices may be initially organized in a set of predetermined fields used by the corresponding reporting device. The collected data may then be parsed and mapped into a schema used by a monitoring system so that the data from different devices can be homogeneously correlated with each other for threat analysis by the monitoring system. The monitoring system schema may have different fields then the reporting device schemas or the reporting devices may put different data in user-defined fields of their schemas or different reporting devices may put the same type of data in different fields. Accordingly, it is difficult to accurately map the reporting device data into the monitoring system schema, which can impact the accuracy of the analysis of the collected data for security threats.

### BRIEF DESCRIPTION OF DRAWINGS

The embodiments are described in detail in the following description with reference to the following figures.

FIG. 1 illustrates a system, according to an embodiment;

FIG. 2 illustrates a main event table, according to an embodiment;

FIG. 3 illustrates a method for mapping and analyzing event data, according to an embodiment;

FIGS. 4A-B illustrate a method for determining a best fit domain, according to an embodiment;

FIG. 5 illustrates a method for determining a best fit domain, according to an embodiment;

FIG. 6 illustrates a method for determining a candidate set of domain schemas based on event relevance percentage, according to an embodiment;

FIG. 7 illustrates a method for determining a candidate set of domain schemas based on domain relevance percentage; and

FIG. 8 illustrates a computer system that may be used for the methods and system, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent that the embodiments may be practiced without limitation to all the specific details. Also, the embodiments may be used together in various combinations.

According to an embodiment, a information and event management system (IEM) collects event data from sources including network devices and applications, and correlates collected event data with a domain. A domain is a category or type of data. For example, event data from credit card transactions is associated with a credit card domain; event data from stock transactions is associated with a stock domain; event data from a human resources application is associated with a human resources domain, etc. Domains may include industry verticals, which include related industries. A domain schema may be stored for each domain. A schema may include a data structure including fields, which are relevant to the domain.

The IEM determines a best fit domain schema and maps the collected event data to their best fit domain schema. The IEM may also auto-create domains and their domain-specific fields if no domain or field is found. The IEM allows the storage of fields to be transparent to network devices or intermediate systems that collect event data and send the data to the IEM. By associating the collected event data with domains, the data can be more accurately analyzed to determine security threats.

An event is any activity that can be monitored and analyzed. Data captured for an event is referred to as event data. The analysis of captured event data may be performed to determine if the event is associated with a threat. Event data may be aggregated for threat analysis. A threat may be associated with fraudulent behavior or other inappropriate, suspicious, or unauthorized behavior. Examples of activities associated with events may include logins, logouts, sending data over a network, sending emails, accessing applications, reading or writing data, performing transactions, etc. An example of a common threat is a network security threat whereby a user is attempting to gain unauthorized access to confidential information, such as social security numbers, credit card numbers, etc., over a network.

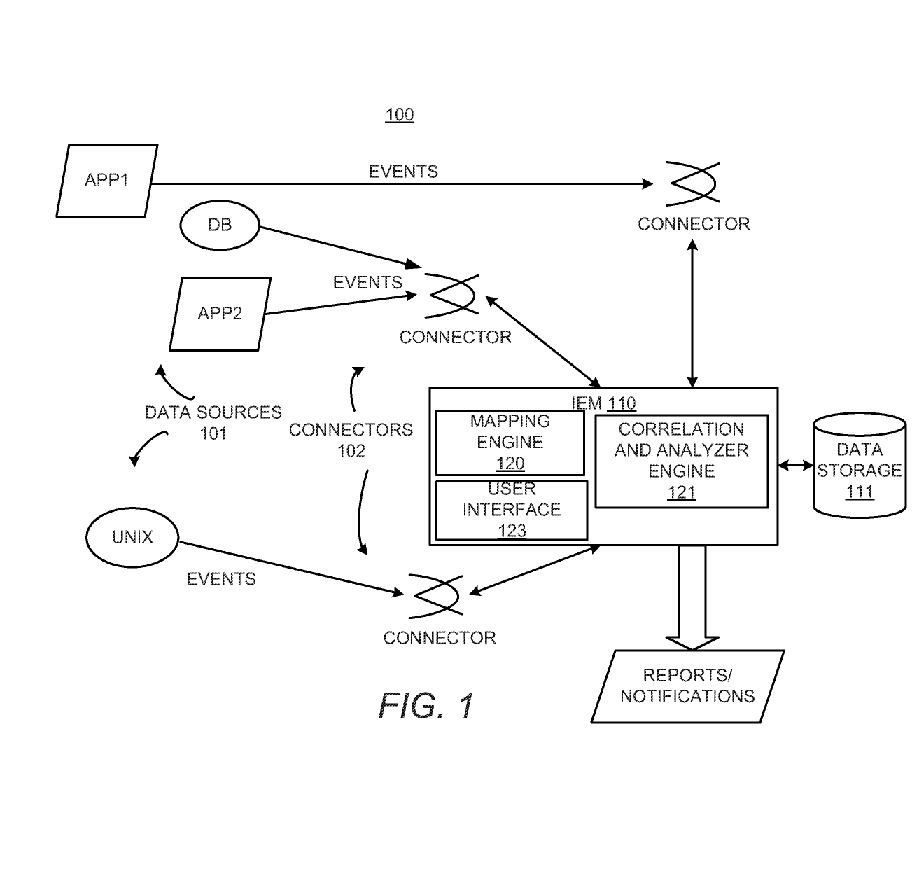

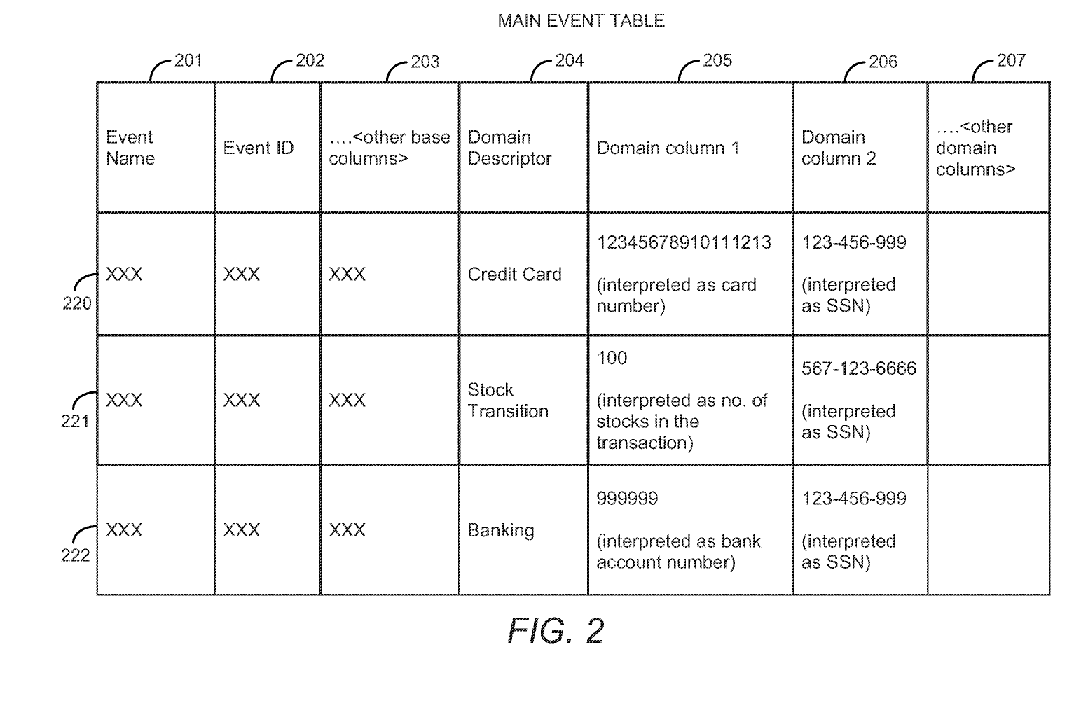

FIG. 1 illustrates an environment 100 including an IEM 110, according to an embodiment. The environment 100 includes data sources 101 generating event data for events, which are collected by the IEM 110 and stored in the data storage 111. The data storage 111 may include a database or other type of data storage system. The data storage 111 may include memory for performing in-memory processing and/or non-volatile storage for database storage and operations. The data storage 111 stores any data used by the IEM 110 to correlate and analyze event data.

The data sources 101 may include network devices, applications or other types of data sources described below operable to provide event data that may be analyzed, for example, to identify threats. Event data may be captured in logs or messages generated by the data sources 101. For example, intrusion detection systems (IDSs), intrusion prevention systems (IPSs), vulnerability assessment tools, firewalls, anti-virus tools, anti-spam tools, encryption tools, and business applications may generate logs describing activities performed by the source. Event data may be provided, for example, by entries in a log file or a syslog server, alerts, alarms, network packets, emails, or notification pages.

Event data can include information about the device or application that generated the event and when the event was received from the event source (“receipt time”). The receipt time may be a date/time stamp, and the event source is a network endpoint identifier (e.g., an IP address or Media Access Control (MAC) address) and/or a description of the source, possibly including information about the product's vendor and version. The data/time stamp, source information and other information is used to correlate events with a user and analyze events for threats.

Examples of the data sources 101 are shown in FIG. 1 as Database (DB), UNIX, App1 and App2. DB and UNIX are systems that include network devices, such as servers, and may generate event data. App1 and App2 are applications that are hosted for example by the DB systems respectively, and also generate event data. App1 and App2 may be business applications, such as financial applications for credit card and stock transactions, IT applications, human resource applications, or any other type of applications.

Other examples of data sources 101 may include security detection and proxy systems, access and policy controls, core service logs and log consolidators, network hardware, encryption devices, and physical security. Examples of security detection and proxy systems include IDSs, IPSs, multipurpose security appliances, vulnerability assessment and management, anti-virus, honeypots, threat response technology, and network monitoring. Examples of access and policy control systems include access and identity management, virtual private networks (VPNs), caching engines, firewalls, and security policy management. Examples of core service logs and log consolidators include operating system logs, database audit logs, application logs, log consolidators, web server logs, and management consoles. Examples of network devices includes routers and switches. Examples of encryption devices include data security and integrity. Examples of physical security systems include card-key readers, biometrics, burglar alarms, and fire alarms.

Connectors 102 may include code comprised of machine readable instructions that provide event data from the data sources 101 to the IEM 110. The connectors 102 may provide efficient, real-time (or near real-time) local event data capture and filtering from the data sources 101. The connectors 102, for example, collect event data from event logs or messages. The collection of event data by the connectors 102 is shown as “EVENTS” describing some data sent from the data sources 101 to the collectors 102 in FIG. 1. The connectors 102 may reside at the data sources 101 or at intermediate points between the data sources 101 and the IEM 110. For example, the connectors 102 may reside at network devices, at consolidation points within the network, and/or operate through simple network management protocol (SNMP) traps. The connectors 102 send the event data to the IEM 110. The collectors 102 may be configurable through both manual and automated processes and via associated configuration files. Each connector may include one or more software modules including a normalizing component, a time correction component, an aggregation component, a batching component, a resolver component, a transport component, and/or additional components. These components may be activated and/or deactivated through appropriate commands in the configuration file.

The IEM 110 includes a mapping engine 120, a correlation engine and analyzer engine 121, and a user interface 123. The mapping engine 120 receives and stores event data in the data storage 111. The event data received from the data sources 101 may be organized in a schema particular to the data source providing the event data. These schemas are referred to as source schemas. The mapping engine 120 maps the event data in the source schemas to a domain schema that is selected based on a matching process.

The IEM 110 stores domain schemas in the data storage 111. The domain schemas, for example, have fields, and one or more of the fields may or may not be the same as the fields of the source schemas, and one or more of the fields may be specific to the domain. For example, a credit card domain schema may have a field for credit card number, while a stock transaction domain schema may not have a field for credit card number but has fields for stock transition type, purchase price, sale price, etc., that are specific to that domain. The mapping engine 120 compares fields in event data with domain schema fields to identify a domain schema that is associated with the event data. In one embodiment, field comparison may include determining whether field names are the same or similar to determine if fields in event data and a domain schema match. This process may be performed for each event having event data received from the data sources 101 and is described in further detail below. If the mapping engine 120 is able to identify a matching domain schema, the mapping engine 120 maps the event data to that domain schema and stores the event data in the data storage 111 with associated domain descriptors, which describe the domain for each collected event if determinable.

The correlation and analyzer engine 121 correlates and analyzes event data, for example, to identify threats or determine other information associated with events. Correlating and analyzing event data may include automated detection and remediation in near real-time, and post analytics, such as reporting, pattern discovery, and incident handling.

Correlation may include correlating event data with users to associate activities described in event data from data sources 101 with particular users. For example, from a user-defined set of base event fields and event end time, a mapping is done to attribute the event to a user. For example, event data may include a unique user identifier (UUID) and application event fields and these fields are used to look up user information in the data storage 111 to identify a user having those attributes at the time the event occurred. Examples of attributes that are used to describe a user and perform lookups may include UUID, first name, middle initial, last name, full name, IDM identifier, domain name, employee type, status, title, company, organization, department, manager, assistant, email address, location, office, phone, fax, address, city, state, zip code, country, account ID, etc.

Correlation may also include correlating events across different domains. For example, fraudulent online banking transactions are correlated to an account tied to wire-fraud or credit-card fraud. In another example, an attack was detected, which was allowed in by the firewall, and it targeted a machine that was found to be vulnerable by a vulnerability scanner. Correlating the event information can imply that the attack has compromised that machine.

Analyzing event data may include using rules to evaluate each event with network model and vulnerability information to develop real-time threat summaries. This may include identifying multiple individual events that collectively satisfy one or more rule conditions such that an action is triggered. The aggregated events may be from different data sources and are collectively indicative of a common incident representing a security threat as defined by one or more rules. The actions triggered by the rules may include notifications transmitted to designated destinations (e.g., security analysts may be notified via consoles e-mail messages, a call to a telephone, cellular telephone, voicemail box and/or pager number or address, or by way of a message to another communication device and/or address such as a facsimile machine, etc.) and/or instructions to network devices to take action to thwart a suspected attack (e.g., by reconfiguring one or more of the network devices, and or modifying or updating access lists, etc.). The information sent with the notification can be configured to include the most relevant data based on the event that occurred and the requirements of the analyst. In some embodiments, unacknowledged notifications result in automatic retransmission of the notification to another designated operator. Also, a knowledge base may be accessed to gather information regarding similar attack profiles and/or to take action in accordance with specified procedures. The knowledge base contains reference documents (e.g., in the form of web pages and/or downloadable documents) that provide a description of the threat, recommended solutions, reference information, company procedures and/or links to additional resources. Indeed, any information can be provided through the knowledge base. By way of example, these pages/documents can have as their source: uses-authored articles, third-party articles, and/or security vendors' reference material.

As part of the process of identifying security threats, events are examined to determine which (if any) of the various rules being processed in the IEM 110 may be implicated by a particular event or events. A rule is considered to be implicated if an event under test has one or more attributes that satisfy, or potentially could satisfy, one or more rules. For example, a rule can be considered implicated if the event under test has a particular source address from a particular subnet that meets conditions of the rule. Another way a rule may be implicated is if the rule has an attribute indicating it is associated with a particular domain schema. For example, a rule is identified for the domain schema for an event and determines if an action, such as a notification, is triggered, Events may remain of interest in this sense for designated time intervals associated with the rules and so by knowing these time windows events can be stored and discarded as warranted. Any interesting events may be grouped together and subjected to further processing.

The IEM 110 maintains reports regarding the status of security threats and their resolution. The IEM 110 provides notifications and reports through the user interface 123 or by sending the information to users or other systems. Users may also enter domain schema information and other information via the user interface 123.

According to an embodiment, the IEM 110 stores event data in a main event table, which may be a database table stored in the data storage 111. The main event table includes domain field columns having predetermined data types and each domain field column is configured to store event data for any domain field of the domain schemas or source schemas if the domain field of the schema has a matching data type for the domain field column of the main event data table.

The mapping engine 120 receives event data for each event and stores the event data in the main event table. Each row in the main event table represents an event and each column represents a field of the event. The mapping engine 120 identifies a best fit domain schema for the event data in each row if one can be identified. The mapping engine 120 stores a domain descriptor for each row that indicates the best fit domain schema. Also, for each row in the main event table, the mapping engine 120 also stores metadata indicating the mapping of each column in the main event table to a field in the corresponding best fit domain. The mapping may be used by the correlation and analyzer engine 121 to query, correlate and analyze event data for security threats.

FIG. 2 illustrates a main event table with examples of event data that may be stored in the main event table. The main event table may include base columns 201-203, such as event name, event ID, and other base columns. The base columns store event data that may be generic to the source schemas. Data is shown as “xxx” for the base columns 201-203, but that data may be provided in the event data received from the data sources 101 and the connectors 102 and is populated in the base columns 201-203.

Column 204 includes the domain descriptor for the domain matched for a particular event. Columns 205-207 are domain fields and include event data that may be specific to the matched domain. For each row representing an event, the mapping engine 120 maps the data stored in the columns 205-207 to the corresponding fields in the domain schema identified by the domain descriptor. This mapping may be stored as the metadata for each domain schema. Each field represented by a column in the main event table may have a data type, such as string, number, date, IP address, etc. The mapping stored as metadata for each row and domain may include display name, data type, field type (e.g., whether a domain or a base field) and underlying columns from the main event table that the domain schema fields map to.

For example, row 220 includes event data for an event from a credit card application; row 221 includes event data for an event from a stock application; and row 222 includes event data for an event from a banking application. Each row has a domain descriptor of the domain schema determined to match the event data. Column 205 is mapped as CreditCardNumber for the credit card domain schema and is mapped as number of stocks bought/sold and bank account number for the Stock Transaction and Banking schemas, respectively. A domain field in the main event table may have the same type of data for each row. For example, column 206 may be mapped to the SSN (Social Security Number) domain field for the credit card, stock transaction and banking domains.

The mapping engine 120 may auto-create fields for the mapping. For example, the connectors 102 may not know that an event is from a particular domain. The connectors 102 may simply send all domain fields to the IEM 110. For received event data, the mapping engine 102 compares the event data with its domain metadata to determine which domain this event substantially matches. For example, if N domains exist, and the fields in that event match best with one of those domains, then the event will be tagged with that domain's descriptor. In case any of the fields from the event does not exist, that field may be auto-created in the domain schema. If the event does not substantially match any of the existing domain schemas, then a new domain schema may be created with fields as per the currently processed event.

Through this mapping, there may be no need to do expensive joins of tables, which allows faster processing. Also, the connectors 102 can send event data without associating the event data with a domain. From the user's and connector's perspective, the IEM 110 has a flexible schema that can accommodate new domains and domain fields. Users can modify and create new domain schemas as needed. Also, the IEM 110 can auto-detect and auto-create new fields in a domain or create a new domain. Through the flexible domain schemas and mapping, the IEM 110 provides the ability to monitor not only “classical” security events but also events from other domains, such as human resources, insurance, finance, etc, and the events may be aggregated across domains to identify threats.

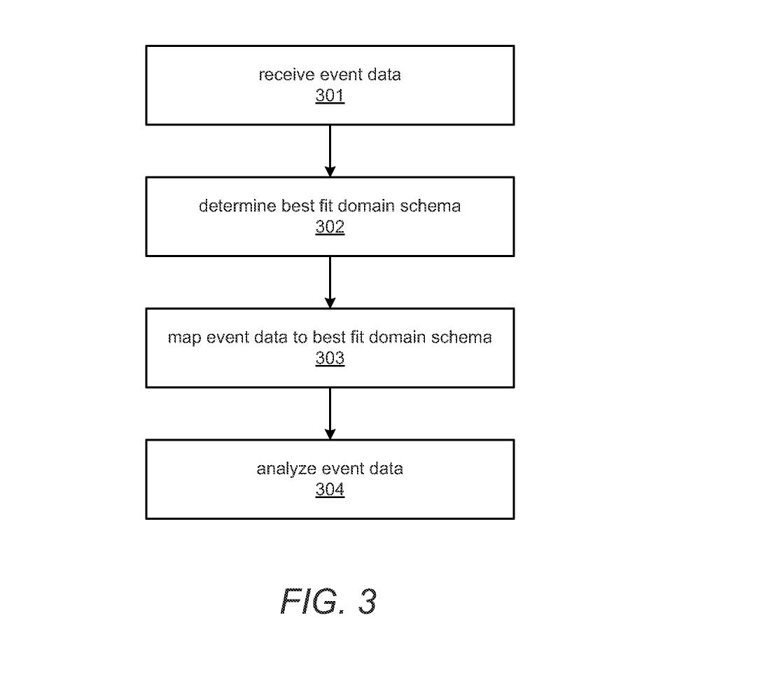

FIG. 3 illustrates a method 300 for mapping and analyzing event data, according to an embodiment. The method 300 and other methods described below may be performed by the IEM 110 shown in FIG. 1 by way of example and not limitation. The methods may be practiced in other systems. Also, one or more of the blocks in the methods may be performed in a different order than shown or substantially simultaneously. Also, details of one or more of the blocks of the method 300 are described in the methods below following the description of the method 300.

At 301, the IEM 110 receives event data for an event. The event data may be arranged in a source schema of a data source providing the event data.

At 302, a best fit domain schema is determined for the event data from domain schemas, which may be stored in the data storage 111. The domain schemas may include different fields from the source schema.

At 303, the event data in the source schema is mapped to the best fit domain schema. For example, the mapping engine 120 stores the event data in a main event table, such as the main event table shown in FIG. 2. The mapping engine 120 stores metadata identifying a domain field from the best fit domain schema to a column in the main event table for each column of the main event table storing data for the event data.

At 304, the event data is analyzed for a security threat based on the best fit domain schema. For example, the correlation and analyzer engine 121 may identify rules applicable to the domain schema for the event data. The correlation and analyzer engine 121 may determine if any actions in the rules are triggered, such as notifying of the security threat in response to detection of the security threat. The method 300 may be repeated for each received event, and each received event may be mapped to a domain schema if one is identifiable as being a best fit.

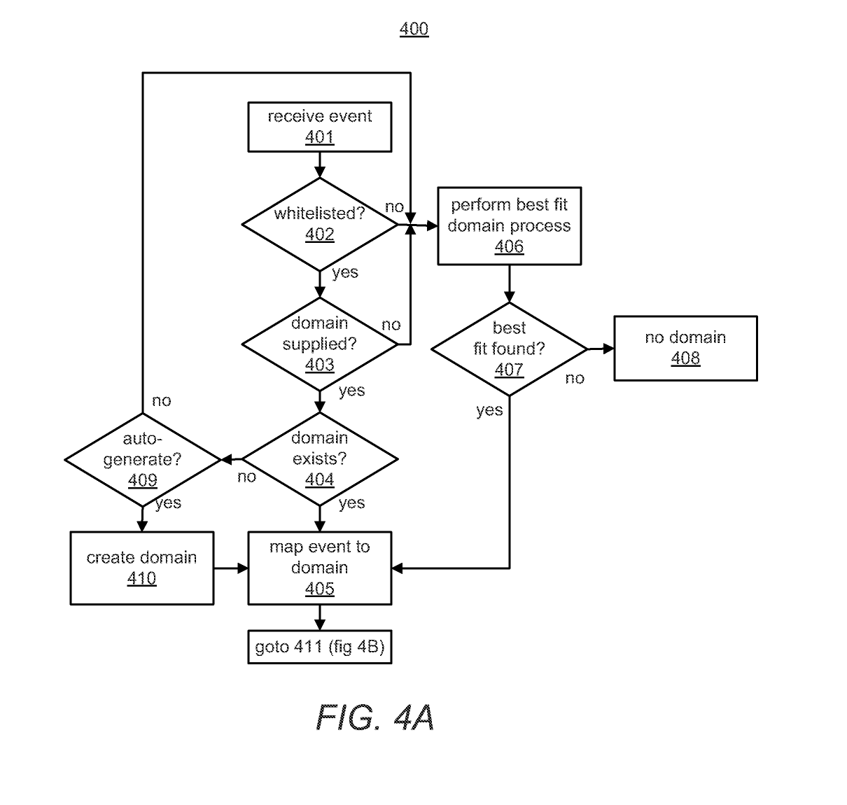

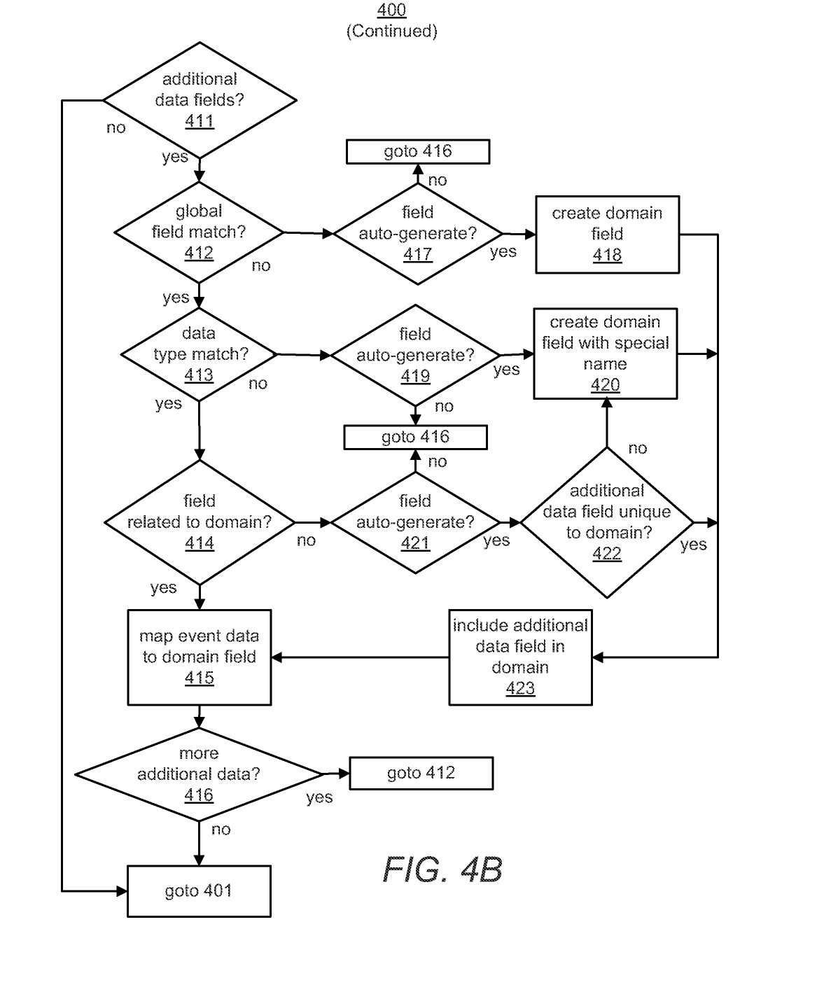

FIGS. 4A-B illustrate a method 400 for event processing. The method 400 includes more details for blocks 302 and 303 in the method 300. At 401, event data for an event is received at the IEM 110 (same as block 301).

At block 402, the IEM 110 determines if the data source for the event is whitelisted. For example, a whitelist is used to identify event data that does not have to go through the best fit domain matching process. The whitelist may identify data sources, including connectors, that provide event data that does not have to go through the best fit domain matching process. The user may specify the data sources on the whitelist. The whitelist may identify the domain schema for the data sources. In one embodiment, the connector determines the domain and notifies the IEM 110 of the domain for the event. The IEM 110 then doesn't run through its best fit domain process. At block 406, if the event is not whitelisted, the IEM 110 performs the best fit domain matching process at block 406. If a best fit domain schema is found at block 407, then block 405 is performed; otherwise, no domain schema is associated with the event at block 408.

At block 403, the IEM 110 determines if a domain schema is supplied on the whitelist for the event if the data source for the event is whitelisted. If no domain schema is supplied, then processing proceeds to block 406.

At block 404, the IEM 110 determines if the supplied domain schema determined from block 403 exists as one of the domain schemas stored in the data storage 111. If the domain schema exists, the event is mapped to the domain schema at block 405 by the mapping engine 120. If the domain schema does not exist as determined at block 404, then the IEM 110 determines at block 409 if domain auto-generate is enabled. This may be a user setting that allows auto-generation to be enabled or disabled. If enabled, a new domain schema is created for the event data from the fields in the source schema for the event data, and the event data is mapped to the new domain.

The method 400 is continued in FIG. 4B. At 411, the IEM 110 determines if the event data includes additional data, which may include any fields in the event data that were not matched with fields in the domain schema mapped at block 405 from FIG. 4A. If no additional data, then processing proceeds to block 401.

If there are one or more additional data fields, the IEM 110 determines if the additional data field has a global field match at block 412. A global field may include any field from any of the domain schemas stored in the data storage 111. If there is no global field match, the IEM 110 determines if field auto-generate is enabled at block 417, This may be a user setting. If the field auto-generate is enabled, the domain field is created at block 418 and added to the domain schema at block 423. If the auto-generate field is not enabled at block 417, processing proceeds to block 416.

If the additional data field is the same as a global field (i.e., there is a global field match), then the IEM 110 determines if the additional data field has the same data type as the global field at block 413. If the data type is not the same, the IEM 110 determines if auto-generate field is enabled at block 419. If the auto-generate field is enabled, a new domain field is created with a special name at block 420 for the additional data and added to the domain schema at block 423. The new domain field may be given a new name so as not to overwrite data from a global field including the same field name. If the field auto-generate is not enabled at block 419, processing proceeds to block 416.

If there is a data type match at block 413, the IEM 110 determines if the additional data is related to the domain of the domain schema at block 414. This may be based on user input. If the additional data is not related to the domain, the IEM 110 determines if field auto-generate is enabled at block 421. If the field auto-generate is not enabled, processing proceeds to block 416. If the field auto-generate is enabled, the IEM 110 determines if the field for the additional data is unique to the domain or is it included in other domains at block 422. For example, a credit card field may be unique to a credit card domain but a social security field may not. If the additional data field is unique to the domain, then the additional data field is added to the domain schema at block 423. If not, a new domain field is created with a special name at block 420 for the additional data field and added to the domain schema at block 423.

If the additional data is related to the domain at block 414, the event data in the related additional data field is mapped to the domain field at block 415. Also, if the additional data field from the event data is included in the domain schema at 423, the event data is mapped to the domain field included in the domain schema at 415. If there is more additional data as determined at block 416, the blocks shown in FIG. 4B are repeated to determine whether to add the field for the additional data to the domain schema. If there is no more additional data, the method 400 is repeated for another received event. The method 400 may be performed for each event received at the IEM 110.

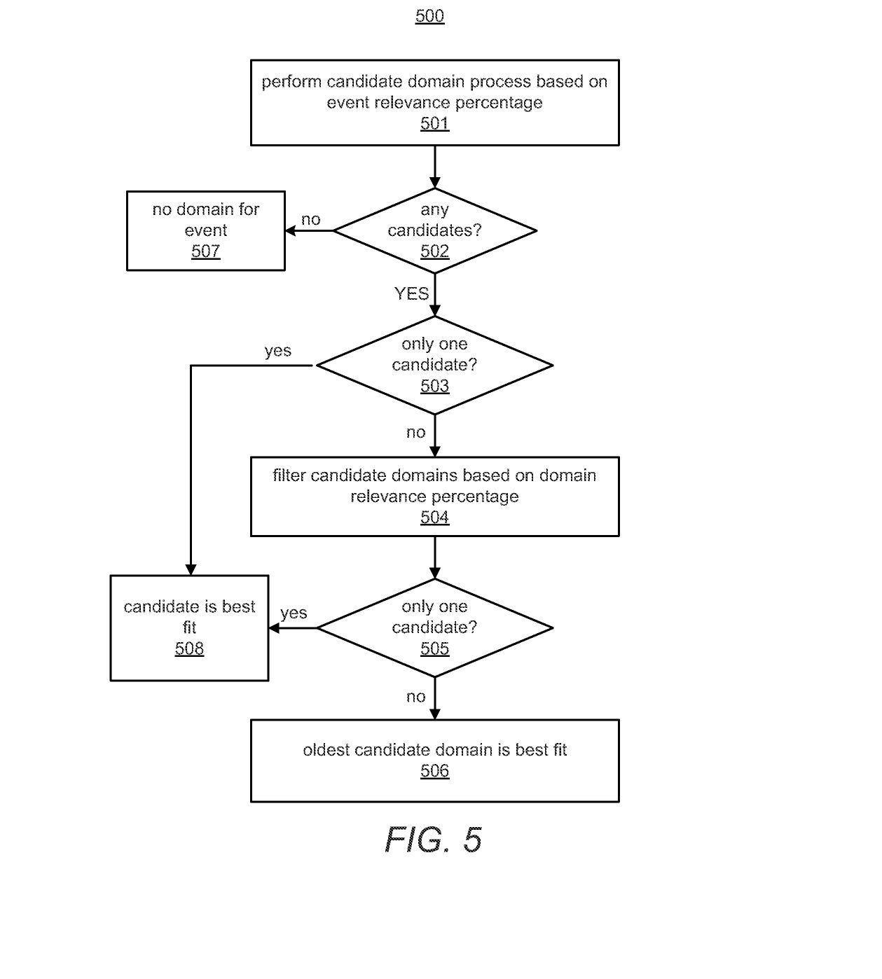

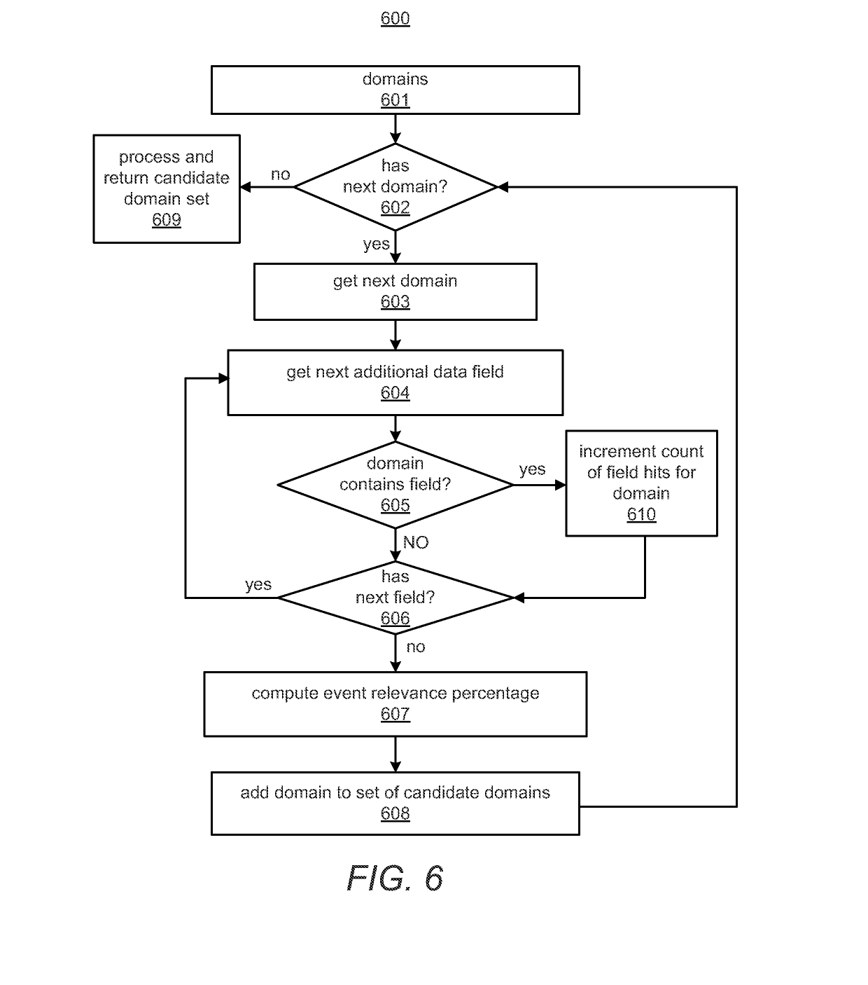

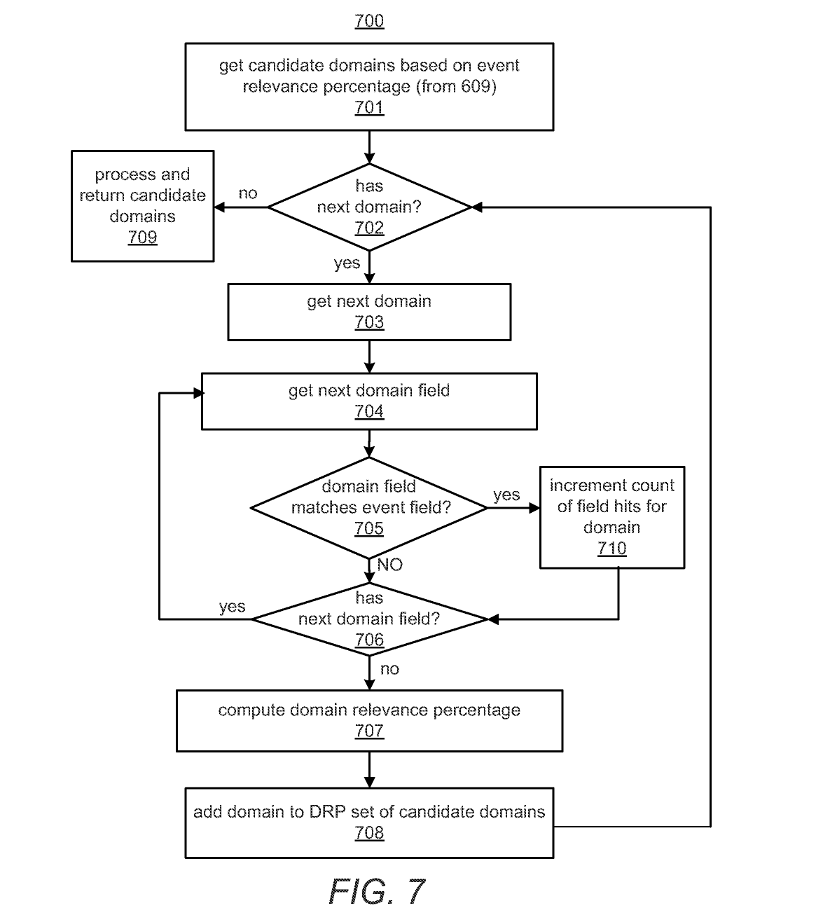

FIG. 5 illustrates a method 500 for determining best fit domain schema, according to an embodiment. The method 500 may be performed for block 302 in the method 300 and block 406 in the method 400. At 501, a candidate domain process is performed to identify any candidate domain schemas for the best fit domain based on an event relevance percentage. This process is further described with respect to FIG. 6. At 502, the IEM 110 determines if any candidate domain schemas are identified. If not, no domain schema is identified for the event at 507. If any candidate domain schemas are identified, the IEM 110 determines if only one candidate domain schema is identified at 503. If yes, the candidate domain schema is determined to be the best fit domain schema at 508. If more than one candidate domain schema is identified, the IEM 110 filters the candidate domain schemas based on a domain relevance percentage at 504. The filtering process is described with respect to FIG. 7. If only one candidate domain schema remains after the filtering, that candidate domain schema is determined to be the best fit domain schema at 508. If more than one candidate domain schema remains after the filtering, the oldest candidate domain schema is selected as the best fit domain schema at 506. The oldest candidate domain schema may be determined from a creation date and time. The candidate domain schema with the earliest data and time is selected as the oldest. Although not shown, if multiple candidate domain schemas are the same age, then the first returned domain schema from the data storage 111 may be selected as the best fit domain schema.

FIG. 6 illustrates a method 600 for determining candidate domain schemas based on event relevance percentage (ERP). The method 600 may be performed as the candidate domain process referred to in block 501 in the method 500. At 601, the domain schemas stored in the data storage 111 are the input, one by one, into the method 600. If all the domain schemas have not been processed as determined at 602, the next domain schema is retrieved at 603.

The additional data fields for the event data are determined. These may include data fields in the event data that are not base fields, such as the base fields shown in FIG. 2. The additional data fields in the event data are processed to determine if they match domain fields in the domain schema at blocks 604-606 and 610. A number of additional data fields from the event data matching domain fields in the domain schema are determined, for example, by incrementing a counter at 610.

At 607, an ERP is computed for the event and the domain schema. For example, ERP is a number of matching fields between the additional data fields and the domain schema divided by the total number of additional data fields in the event. At 608, the domain schema and its ERP are added to the candidate set. The method 600 is performed for all the domains so the ERP is determined for all the domains and preliminary included in the candidate set. At 609, the candidate set of domain schemas is processed to determine the candidate set to return to blocks 501 and 502 in the method 500.

Processing the candidate set may include comparing the ERP for each domain schema to a threshold and keeping domain schema(s) having the highest ERP. If the ERP is greeter than or equal to the threshold, then the domain schema is preliminarily kept in the candidate set. After comparison of each ERP to the threshold, if only one domain schema has a highest ERP, then that domain schema is maintained as the only domain schema in the candidate set. If more than one domain schema has the highest ERP, then each of those domain schemas are kept in the candidate set and all others are removed. By way of example, the event has 10 fields in its additional data. Domain 1 has 8 of those fields; domain 2 has 7 of those fields; and domain 3 has 9 of those fields. This yields domain 1 ERP=80%; domain 2 ERP=70%; and domain 3 ERP=90%. D3 is chosen as the only candidate domain schema because it has the highest ERP. In a second example, the event has 10 fields, and domain 1 has 7 of them; domain 2 has 6 of them; and domain 3 has 3 of them. This yields domain 1 ERP=70%;

domain 2 ERP=60%; and domain 3 ERP=30%. No Domain is chosen if the threshold is 80% and the candidate set is null. In a third example, the event has 10 fields, and domain 1 has 8 of them; domain 2 has 7 of them; and domain 3 has 8 of them. This yields domain 1 ERP=80%; domain 2 ERP=70%; and domain 3 ERP=80%. Both D1 and D3 are kept in the candidate set.

FIG. 7 illustrates a method 700 for filtering the domains in the candidate set based on domain relevance percentage (DRP), such as performed at step 504 in the method 500. At 701, the domain schemas from the candidate set determined at block 609 are the input, one by one, into the method 700. If all the domain schemas in the candidate set have not been processed as determined at 702, the next domain schema is retrieved at 703.

The additional data fields for the event data are determined. The additional data fields in the event data and the domain fields in the domain schema from the candidate set are processed at blocks 704-706 to determine a number of additional data fields from the event data matching the domain fields in the domain schema, for example, by incrementing a counter at 710.

At 707, a DRP is computed for the event and the domain schema. For example, DRP is a number of matching fields between the additional data fields and the domain schema divided by the total number of domain fields in the domain schema. At 708, the domain schema and its DRP are included a DRP candidate set. The method 700 is performed for all the domain schemas in the candidate set from block 609 so the DRP is determined for all the domain schemas and preliminary included in the DRP candidate set. At 709, the DRP candidate set of domain schemas is processed to determine the candidate set to return to blocks 501 and 502 in the method 500.

Processing the DRP candidate set may include determining the highest DRP and including the domain schema having the highest DRP in the final candidate set. By way of example, domain 1 has 10 domain fields of which 8 match the fields of the event; domain 2 has 10 domain fields of which 7 match; and domain 3 has 10 domain fields of which 9 match. This yields domain 1 DRP=80%; domain 2 DRP=70%; and domain 3 DRP=90%. Domain 3 schema is chosen as the only candidate domain schema because it has the highest DRP. In a second example, domain 1 has 10 domain fields of which 8 match the fields of the event; domain 2 has 10 domain fields of which 7 match; and domain 3 has 10 domain fields of which 8 match. This yields domain 1 DRP=80%; domain 2 DRP=70%; and domain 3 DRP=80%. In this example, both domains 1 and 3 are in the candidate set.

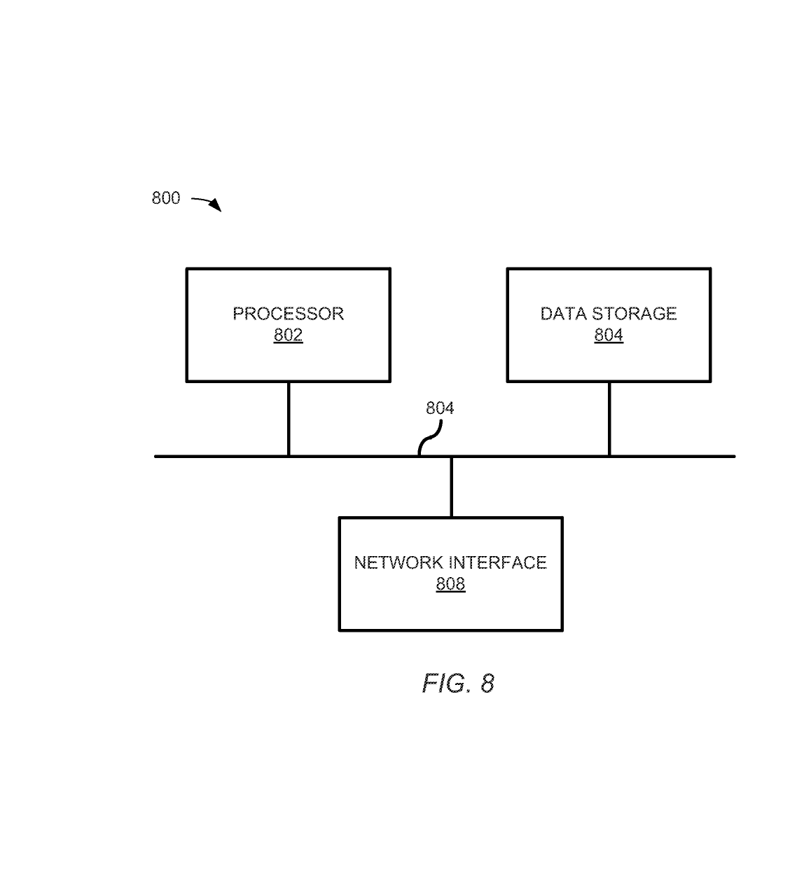

FIG. 8 shows a computer system 800 that may be used with the embodiments described herein. The computer system 800 represents a generic platform that includes components that may be in a server or another computer system or in components of a computer system. The computer system 800 may be used as a platform for the IEM 110 shown in FIG. 1. The computer system 800 may execute, by a processor or other hardware processing circuit, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory),

The computer system 800 includes a processor 802 or other hardware processing circuit that may implement or execute machine readable instructions performing some or all of the methods, functions and other processes described herein. Commands and data from the processor 802 are communicated over a communication bus 808, The computer system 800 also includes data storage 804, such as random access memory (RAM) or another type of data storage, where the machine readable instructions and data for the processor 802 may reside during runtime. Network interface 808 sends and receives data from a network. The computer system 800 may include other components not shown.

While the embodiments have been described with reference to examples, various modifications to the described embodiments may be made without departing from the scope of the claimed embodiments.

What is claimed is:

1. A method of mapping event data to a domain schema, the method comprising:
receiving (301) event data for an event, wherein the event data is arranged in a source schema of a data source providing the event data;
determining (302), by a processor, a best fit domain schema from a plurality of domain schemas, wherein the domain schemas include different fields from the source schema; and
mapping (303) the event data in the source schema to the determined best fit domain schema.

2. The method of claim 1, wherein determining a best fit domain schema comprises:
for each of the domain schemas, calculating an event relevance percentage (ERP) based on a number of fields in the domain schema matching the source schema;
determining (501) if there is more than one candidate schema based on the ERPs;
if there is more than one candidate schema, determining a domain relevance percentage (DRP) (504) for each of the candidate schemas based on matching domain fields in the candidate schema; and
selecting (506, 508) one of the candidate schemas as the best fit domain schema based on the DRPs.

3. The method of claim 2, comprising:
wherein determining if there is more than one candidate schema comprises comparing for each domain schema the ERP to a threshold and selecting the domain schema as a candidate schema if the ERP is greater than or equal to the threshold (609); and
if there is only one candidate schema, selecting (508) the candidate schema as the best fit domain schema.

4. The method of claim 2, wherein selecting one of the candidate schemas as the best fit domain schema based on the DRPs comprises:
determining a highest DRP for the candidate schemas;
if more than of the candidate schemas has the highest DRP, selecting an oldest one of the candidate schemas having the highest DRP as the best fit domain schema (709); and
if only one of the candidate schemas has the highest DRP, selecting the candidate schema having the highest DRP as the best fit domain schema.

5. The method of claim 1, wherein prior to determining the best fit domain schema, the method comprises:
determining (402) whether the event is on a whitelist;
if the event is on the whitelist, determining if a domain schema is indicated for the event (403);
if a domain schema is indicated for the event, determining (404) if the indicated domain schema is one of the plurality of domain schemas;
if the indicated domain schema is one of the plurality of domain schemas, selecting (405) the indicated domain schema to map the event data.

6. The method of claim 5, comprising:
if the event is not on the whitelist or if the indicated domain schema is determined to be not one of the plurality of domain schemas, then auto-generating (409) a new domain schema from the source schema if auto-generating is enabled and selecting the new source schema to map the event data.

7. The method of claim 1, comprising:
determining (411) whether the event data includes an additional field that is not included in the best fit domain schema;
if the event data includes the additional field, determining (412) whether the additional field is a global field in one of the plurality of domain schemas;
if the additional field is the global field, determining (413) if the additional field has a data type that matches the global field;
if the additional field has a data type that matches the global field, including the additional field in the best fit domain schema (415).

8. The method of claim 7, comprising:
if the additional field has a data type that does not match the global field, including (423) the additional field in the best fit domain schema if auto-generate field is enabled.

9. The method of claim 8, comprising:
if the additional field is not unique to the best fit domain schema, creating (420) a new domain schema under a new domain schema name, the new domain schema including fields of the best fit domain schema and the additional field.

10. The method of claim 1, comprising:
selecting a rule to analyze the event data for a security threat based on the best fit domain schema; and
notifying of the security threat in response to detection of the security threat.

11. The method of claim 1, wherein mapping the event data in the source schema to the determined best fit domain schema comprises:
storing the event data in a main event table, wherein the main event table includes domain field columns having predetermined data types and each domain field column is configured to store event data for any domain field of the plurality of domain schemas if the domain field of the domain schema has a matching data type for the domain field column of the main event data table; and
storing metadata indicating a mapping of each best field domain schema field to a domain field column of the main event table storing the event data.

12. An event management system (110) comprising:
a data storage (804) to store event data for an event, wherein the event data is arranged in a source schema of a data source providing the event data, and a plurality of domain schemas; and
a processor (802) to determine a best fit domain schema from a plurality of domain schemas, wherein the domain schemas include different fields from the source schema, and to map the event data in the source schema to the determined best fit domain schema.

13. The event management system (110) of claim 12, wherein the processor (802) determines a best fit domain schema by, for each of the domain schemas, calculating an event relevance percentage (ERP) based on a number of fields in the domain schema matching the source schema, determining if there is more than one candidate schema based on the ERPs, if there is more than one candidate schema, determining a domain relevance percentage (DRP) for each of the candidate schemas based on matching domain fields in the candidate schema, and selecting one of the candidate schemas as the best fit domain schema based on the DRPs.

14. A non-transitory computer readable medium (804) storing machine readable instructions that when executed by a computer system (800) performs a method comprising:
receiving event data for an event, wherein the event data is arranged in a source schema of a data source providing the event data;
determining, by a processor, a best fit domain schema from a plurality of domain schemas, wherein the domain schemas include different fields from the source schema; and
mapping the event data in the source schema to the determined best fit domain schema.

15. The non-transitory computer readable medium (804) of claim 14, wherein determining a best fit domain schema comprises: for each of the domain schemas, calculating an event relevance percentage (ERP) based on a number of fields in the domain schema matching the source schema, determining if there is more than one candidate schema based on the ERPs, if there is more than one candidate schema, determining a domain relevance percentage (DRP) for each of the candidate schemas based on matching domain fields in the candidate schema, and selecting one of the candidate schemas as the best fit domain schema based on the DRPs.
